(19) United States
(12) Patent Application Publication
(10) Pub. No.: US 2004/0186925 A1
(43) Pub. Date: Sep. 23, 2004

(54) Printing system with retained print job emailing

(76) Inventors: Joe Cooper, Boise, ID (US); Curtis Reese, Boise, ID (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/393,616

(22) Filed: Mar. 21, 2003

(51) Int. Cl. G06F 3/00

(52) U.S. Cl. 710/8

(57) ABSTRACT

A print job is retained on a printer for execution at some future time. An email is transmitted to the printer requesting the print job. The printer responds with an email to a destination address in the requesting email. The responding email includes the retained print job.

### FIELD OF THE INVENTION

The present invention relates generally to printing systems.

### BACKGROUND

Printers have recently been manufactured with imbedded web servers that enable the printer to be accessed over the Internet. A web server provides an environment in which web programs can be executed. The output of these programs can then be displayed on a web browser for use by the printer's user/operator. The web server is considered to be embedded when it resides in a hardware device's firmware instead of as software that is loaded on a client computer or network server.

A printer or other hardware device that has an embedded server typically also incorporates some type of Virtual Machine (VM) that provides an execution environment for programs that make use of industry standard Application Programming Interfaces (APIs). HEWLETT-PACKARD'S CHAIVM® and SUN MICROSYSTEM'S JAVA® Virtual Machines are two examples of such execution environments. Both technologies enable servers to run JAVA applications on practically any platform.

The printer with the embedded server acts substantially like a computer on the Internet. The printer, through the web server, can receive HyperText Transfer Protocol (HTTP) commands from over the Internet and send HyperText Markup Language (HTML) content back to the requester. Depending upon the printer's network configuration, users can access the printer's web server via the Internet or via an intranet that is separated from the Internet with a firewall. In the case of Hewlett-Packard's printers, providing web pages for user access is accomplished through the printer's embedded Webserver application, CHAISERVER®, which is a JAVA application that is executed by the CHAIVM®.

Printers additionally have the ability to retain print jobs for subsequent execution. These retained jobs can be released for printing by navigating the printer's front panel directly. In some cases, retained jobs are protected by a Personal Identification Number (PIN), so that only the job submitter can release the job for printing. In other cases, retained jobs can be created without PINs, and any user can use the printer's front panel to release the job.

One problem with storing a print job on a printer is that the job may be needed subsequently while the print job owner is away from the printer. For example, the owner may transmit a print job to his printer over the company's intranet that is behind a firewall. If the originator then goes to a client's place of business and needs the results of the print job, he cannot use an HTTP request to access the printer from outside the firewall in order to retrieve the print job. The owner would then have to either return to the printer to pick up the job or have someone fax the results to the client's place of business. Either outcome is time consuming and burdensome.

For the reasons stated above, and for other reasons stated below that will become apparent to those skilled in the art upon reading and understanding the present specification, there is a need in the art for a way to access print jobs that have been retained in a printer or other type of printing system, from computing or printing systems located on a disparate network that is separated from the source printer's network by one or more firewalls

### SUMMARY

The embodiments of the present invention encompass a method for handling a print job stored in a printer. The printer receives an email from another printer or computer. The email includes a destination address and print job name. In one embodiment, the destination address is the email address of a second printer.

The printer with the stored print job parses the email to determine the destination address to send the print job. The print job is then packaged with a reply email that is transmitted to the destination address. The print job is received at the destination address and stored and/or printed as a normal job from the print queue. In one embodiment, the email requesting the print job includes a means of identifying the print job owner such as a personal identification number or other personal identification indicator.

Further embodiments of the invention include methods and apparatus of varying scope.

### DESCRIPTION OF THE DRAWINGS

FIG. 1 is a block diagram of one embodiment of a printing device of the present invention.

FIG. 2 is a diagram of one embodiment of a printing system of the present invention.

FIG. 3 is diagram of one embodiment of a print dialog box for print job retention of the present invention.

FIG. 4 is an email message format for requesting emailing of a stored print job in accordance with one embodiment of the present invention.

FIG. 5 is a flowchart of a method for requesting a stored print job to be emailed in accordance with one embodiment of the present invention.

FIG. 6 is a flowchart of a method for receiving an emailed print job in accordance with one embodiment of the present invention.

### DETAILED DESCRIPTION

In the following detailed description of the present embodiments, reference is made to the accompanying drawings that form a part hereof, and in which is shown by way of illustration specific embodiments in which the invention may be practiced. These embodiments are described in sufficient detail to enable those skilled in the art to practice the invention, and it is to be understood that other embodiments may be utilized and that process, electrical or mechanical changes may be made without departing from the scope of the present invention. The following detailed description is, therefore, not to be taken in a limiting sense, and the scope of the present invention is defined only by the appended claims and equivalents thereof.

The descriptions of the embodiments of the present invention refer to a printer or printing system. However, the present invention encompasses any multifunction product technology such as a device that incorporates scanner, printer, and copier functions. The present invention is not limited to any one type of printing system.

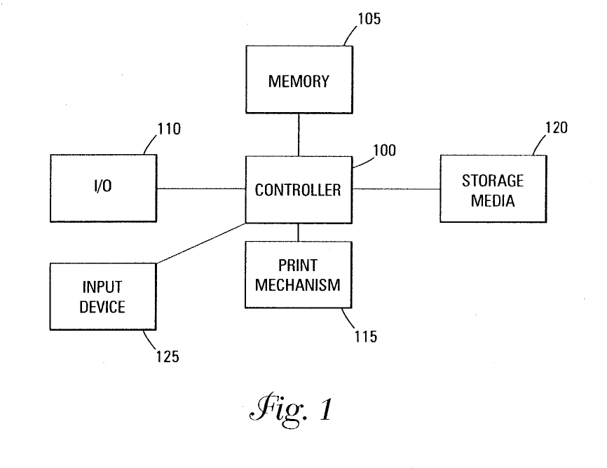

FIG. 1 illustrates a block diagram of one embodiment of a printer or other printing device of the present invention. The printer includes a controller 100 that controls the operation of the printer and executes the methods of the present invention. The controller 100 may be a microprocessor, microcontroller, or other type of controller circuit.

The printer memory 105 may be of the type used for temporary storage of data such as random access memory (RAM). Additionally, the memory 105 may be of the type used for permanent storage of data, such as read only memory (ROM), programmable read only memory (PROM), flash memory, and/or memory cards. Other types of memory, semiconductor or otherwise, can be included as memory.

The printer memory 105 may be used to store printing tasks that have been sent to the printer from one or more computers on a network, directly from a host computer, or by data downloaded from a memory card inserted into the printer. In one embodiment, the memory 105 stores the firmware (not shown) that is executed by the controller 100 in order to control the operation of the printer.

The printer may be comprised of additional memory such as storage media 120. The storage media memory 120 can include hard disk drives, floppy disk drives, optical drives, removable solid-state memory cards, or any other type of storage media. The storage media 120 may be fixed and/or removable. The storage media 120 can store print jobs indefinitely until they are scheduled to run. In one embodiment, the storage media 120 can store the embedded web server, virtual machine, and other code required to link the printer to a network such as the Internet. These items can also be stored in the printer memory 105.

The input/output (I/O) connections 110 include any network interface cards required to interface the printer to a network (e.g., Ethernet) (not shown). In another embodiment, the network connection 110 is simply a Universal Serial Bus (USB) port, IEEE 1394 port (FIREWIRE), infrared, or other type of port for coupling the printer to a host device. The present invention is not limited to any one type of network or I/O connection.

In one embodiment, the print job is sent to the printer over an Internet/intranet connection. In another embodiment, the print job to be run is sent to the printer over the I/O connection 110 in multiple packets of data. In yet another embodiment, the print job is transmitted over the I/O connection 110 in a serial bit stream of data. The present invention is not limited to any one means of data transport.

The controller 100 is also coupled to and controls the printer mechanisms 115 of the printer. For example, in an inkjet printer, the printer mechanisms 115 include the inkjet pen(s), the pen carriage device(s), and the roller that feeds the paper through the printer. If the printer is a laser printer, the printer mechanisms 115 may include the toner cartridge, the various feed rollers, the laser mirrors and optics, and the thermal devices required for laser printing. In general, the printer mechanisms 115 are the mechanical components of the printer related to transporting the print media within the printer and transferring a tangible image to the print media.

An input device 125 such as a keypad, touch sensitive display (e.g., liquid crystal display, cathode ray tube), or other type of input device may be coupled to the controller 100 to enable a printer user/operator to input commands or data to the printer controller 100 from the printer control panel.

The block diagram of FIG. 1 is for illustration purposes only. The present invention is not limited to any one printer or printing device architecture.

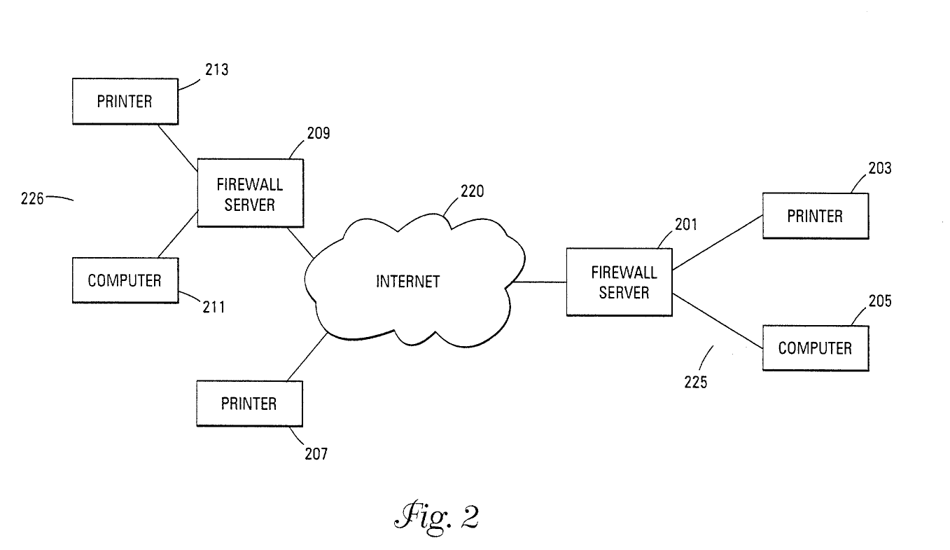

FIG. 2 illustrates a diagram of one embodiment of a printing system of the present invention. This system uses the Internet 220 to communicate between various intranets 225 and 226 and/or printers 207. The present invention, however, is not limited to any one network.

The system illustrated in FIG. 2 is comprised of two intranets 225 and 226. Each intranet 225 and 226 has a firewall server 201 and 209, respectively, that acts as a firewall in order to prevent unauthorized access to the intranet 225 and 226. Printers 203 and 213, such as the one illustrated in FIG. 1, and computers 205 and 211 are shown as being part of each intranet 225 and 226, respectively. Alternate embodiments include multiple printers and computers on each intranet.

A printer 207 is shown being connected directly to the Internet 220. Since the printer 207 has an embedded web server, it does not require an intermediate server in order to communicate over the Internet 220. In an alternate embodiment, this printer 207 also has a hardware firewall (not shown) coupling it to the Internet 220.

One or more of the printers 203, 207, and 213 in the printing system of FIG. 2 have an embedded web server. Such a printer has a unique Internet Protocol (IP) address that allows any computer that knows the address to access the printer with a web browser. This enables the printer to be accessed with HTTP commands. The printer can then reply with HTML content to the requester.

Each printer with an embedded web server is also able to communicate using Simple Mail Transport Protocol (SMTP) to handle outgoing email and Post Office Protocol (POP3) to handle incoming mail. These standards enable the printer to communicate over the Internet via email. The standards and processes used to communicate over the Internet are well known in the art, and are not discussed further.

As an example of operation of the stored print job email request methods of the present invention, a print job is first sent from one computer 205 to a local printer 203. The print job owner decides that he does not want the print job to be run immediately, and uses the printer driver software to specify that the job is to be retained for later use. It is then stored in the printer's memory (e.g., semiconductor, hard drive) (not shown) for later execution.

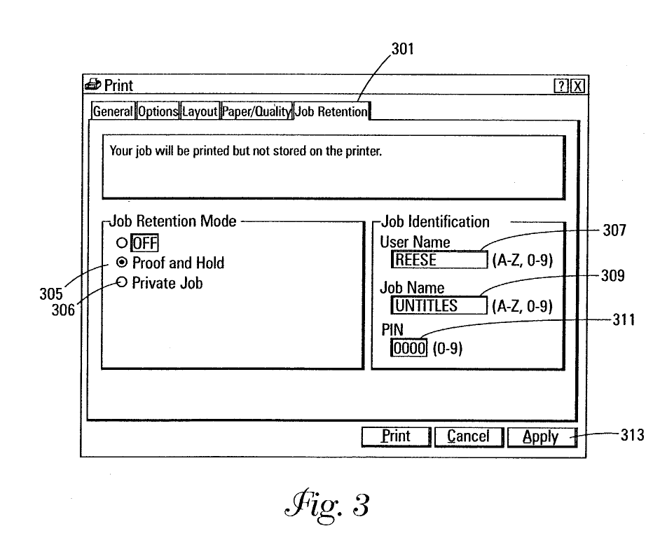

FIG. 3 illustrates a diagram of one embodiment of a print job retention dialog box for use in the present invention. This dialog box, in one embodiment, is part of the printer driver that is installed on a computer so that the computer can communicate with the printer.

The print job owner first brings up the “Job Retention” tab 301 that has the instructions for retaining the print job. The job owner then clicks on either a “Proof and Hold” button 305 to tell the computer that the job is to be retained and not immediately printed or the “Private Job” button 306 to instruct the printer that the job is private and requires a personal identification number (PIN) in order to be accessed. While PIN suggests a number is used, the PIN may be entirely numeric, alphanumeric, or just text. The present invention is not limited to any format of characters to identify the job owner.

The owner types in his name in the “User Name” box 307 and a job name in the “Job Name” box 309 so that the printer can later locate the print job. If the private job button 306 has been enabled, a PIN is required in the PIN box 311 so that the print job is accessible only to the print job owner. The “Apply” button 313 is then pressed to activate the instructions to retain the print job in the printer.

Referring again to FIG. 2, assume that the print job owner travels to another business that uses a separate intranet 226. While there, he desires to have the print job that is stored on the first printer 203. However, that printer 203 is behind a firewall server 201 and cannot be accessed through HTTP requests. Using the print job email methods of the present invention, as discussed subsequently, he sends an email to the original printer 203 requesting that the print job be emailed back to the printer 213 near his present location.

The emailing can be accomplished using the email client software on the computer 211 that is part of the current intranet 226. In an alternate embodiment, the print job owner can use the control panel of the second printer 213 to send the email to the first printer 203 requesting the print job. In yet another embodiment, the computer 211 could be used to interact with the local printer's 213 web interface to generate and transmit an email message to the first printer 203. In any case, since both the first and second printers 203 and 213 are conversant in the email protocols, they are able to communicate over email.

The first printer 203 receives the email, determines the request, and emails the print job back to the second printer 213. The second printer 213 can then remove the attached job, parse it as a normal print job, and run the job so that the print job owner can now conveniently get the results nearby. In another embodiment, the job is retained by the second printer 213 for execution at a future time.

In another embodiment, the email requesting that the print job be sent also contains the PIN that the print job owner input into the print dialog box when he stored the job. The printer 203 receiving the requesting email then performs a match to the stored PIN and emails the print job back if the PINs match. If the PINs do not match, the receiving printer 203 can either ignore the request or send an error message back through an email.

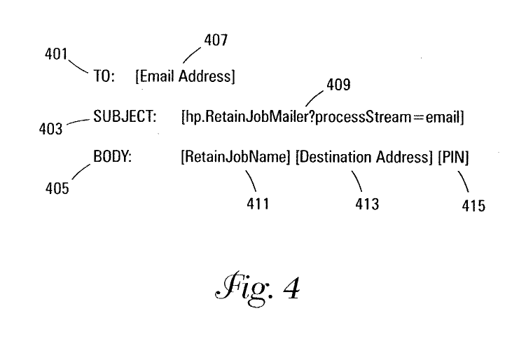

FIG. 4 illustrates one embodiment of an email message of the present invention that requests return of a stored print job. This format is for illustration purposes only and does not limit the present invention to any one email format.

The email has a “TO” field 401 that lists the email address 407 of the printer that is storing the print job. In one embodiment, the email address 407 is in the typical email format of such as: printer2@hp.com. The present invention is not limited to any one email address format or domain name.

A “SUBJECT” field 403 contains the information used by the receiving printer. The receiving printer's embedded web server uses the information 409 in the “SUBJECT” field 403 to route the email to the appropriate application running on the printer. This information may be formatted such that the question mark acts as a field delimiter. The characters prior to this delimiting character represent the application name to which the email is to be routed. In this case it is “hp.RetainJobMailer”. The characters after the delimiting character represent the type of data or process stream the referenced application can expect. In this case, the process stream type is “email”. Alternate embodiments use other types of delimiting characters as well as different formats to express the instructions for which application is to receive the email, and what data is being sent to that application.

A “BODY” field 405 contains information regarding the name of the retained job 411 and the email address 413 of the destination printer. The name of the retained job 411 was entered by the job owner, as discussed previously with reference to FIG. 3. The destination address 413 is the return email address to which the retained job is to be sent for execution. This may have the same formatting as discussed previously.

If the retained job was stored as a private job using a PIN, this field 405 may also have a PIN subfield 415 into which the job owner can type the same PIN used when the job was stored. In alternate embodiments, the PIN field is not required if the job was not designated as being private.

The present invention is not limited to the various fields and subfields of the email format of FIG. 4. The information provided can be listed in any way such that the receiving printer can understand and implement the request.

The emails used in the present invention can also implement some type of encryption algorithm. In one embodiment, the requesting email is not encrypted, but the return email with the print job is encrypted to prevent unauthorized access to the job. In another embodiment, both the requesting and return emails are encrypted.

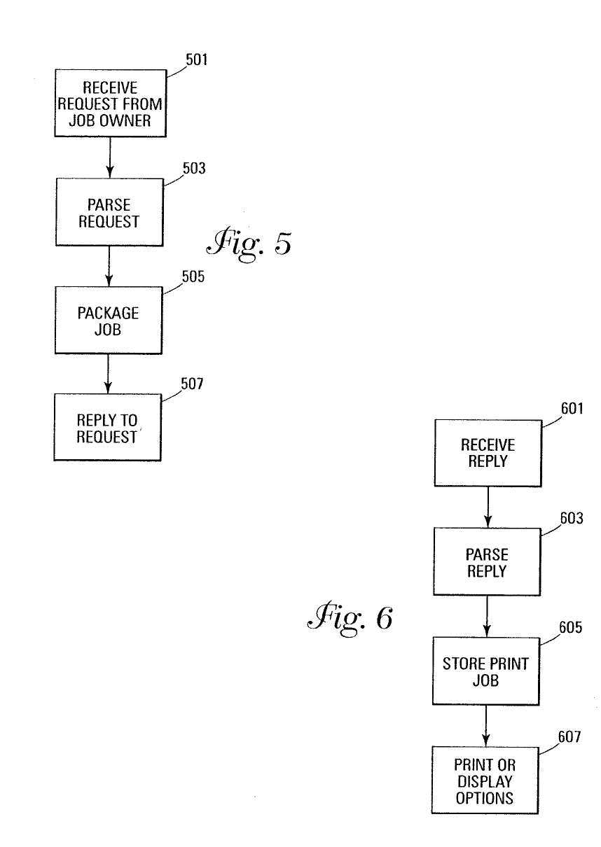

FIG. 5 illustrates a flowchart of a method for requesting a stored print job to be emailed in accordance with one embodiment of the present invention. The printer that has the stored print job receives the email request from the owner 501. The printer's web server parses 503 the various fields and subfields of the email to determine which application running on the printer should get the email. This step may entail verifying the PIN received from the owner if the embodiment stored the print job with a PIN.

If the print job was stored with a PIN, the web server, in one embodiment, does not send the response email if the PIN in the email request and the print job's stored PIN do not match. In another embodiment, the web server sends a response email indicating an error condition in that the two PINs do not match.

The receiving application then packages the print job 505 into an outgoing email message addressed to the printer's whose address is listed in the email. The print job, in one embodiment, is attached to the email message as an attachment.

The email with the print job is sent to the appropriate email address 507. The print job can then either be run on that printer or stored for later execution.

FIG. 6 illustrates a flowchart of a method for receiving an emailed print job in accordance with one embodiment of the present invention. This method is executed by the printer that receives the print job from the original printer.

The receiving printer receives the reply email 601 from the original printer. The printer's web server parses 603 the reply email to determine which application being executed on the printer should receive the email.

The attached print job is removed from the email and stored in the printer's memory 605. Depending on the embodiment, the print job may be stored in the printer's temporary memory that acts as a print queue in order to be executed with other jobs in the print queue. In another embodiment, the print job is stored in permanent memory, such as the printer's hard drive, for execution later.

In order to notify the print job owner that the print job has been received and is now stored in the local printer, a notification 607 is made on the printer's display or a computer that is coupled to the printer directly or over the network. This notification can take the form of a simple text message indicating receipt of the print job and giving the owner options regarding its disposition. For example, a dialog box may come up that lets the owner store it locally or put the print job into the printer's queue for immediate execution.

### Conclusion

In summary, the embodiments of the present invention enable a print job owner to retrieve a stored print job over the Internet. By sending an email to the printer that is storing the print job, that printer can reply to a desired printer with the stored print job so that the desired printer can run the job.

Although specific embodiments have been illustrated and described herein, it will be appreciated by those of ordinary skill in the art that any arrangement that is calculated to achieve the same purpose may be substituted for the specific embodiments shown. Many adaptations of the invention will be apparent to those of ordinary skill in the art. Accordingly, this application is intended to cover any adaptations or variations of the invention.

What is claimed is:

1. A method for handling a retained print job comprising:
transmitting a first email to a first printer, the first email comprising a request for the retained print job that is stored on the first printer; and
receiving a second email from the first printer, the second email comprising the retained print job.

2. The method of claim 1 and further including storing the print job in a second printer.

3. The method of claim 1 and further including executing the print job on a second printer.

4. The method of claim 1 wherein receiving the second email includes a second printer receiving the email.

5. The method of claim 4 and further including the second printer indicating options for disposition of the print job.

6. The method of claim 1 wherein the first and second printers have SMTP and POP3 compliant embedded web servers.

7. The method of claim 1 wherein transmitting the first email includes a computer transmitting the first email over the Internet to the second computer.

8. A method for printing comprising:
transmitting a requesting email to a first printer, the requesting email comprising a request for a retained print job that is stored on the first printer;
receiving a response email from the first printer, the response email comprising the retained print job; and
printing the retained print job on the second printer.

9. The method of claim 8 and further including:
a first computer storing the retained print job in the first printer; and
a second computer transmitting the requesting email.

10. The method of claim 8 wherein the requesting email comprises a personal identification indication identifying the retained print job owner as sending the requesting email.

11. The method of claim 8 wherein the requesting email comprises an email address of the second printer.

12. A method for printing comprising:
transmitting a requesting email to a first printer, the requesting email comprising a destination email address, a retained print job name, and an application name for a second printer, the second printer corresponding to the destination email address;
receiving a response email, at the destination email address, from the first printer, the response email comprising a retained print job corresponding to the retained print job name; and
printing the retained print job on the second printer.

13. The method of claim 12 wherein the application name corresponds to an email parsing process executed by an embedded web server on the second printer.

14. The method of claim 12 wherein the requesting email further includes a personal identification number that further identifies an owner of the retained print job.

15. A method for handling a retained print job comprising:
transmitting a request email to a first printer, the request email comprising a job name for the retained print job that is stored on the first printer and a destination address; and
receiving, at the destination address, a response email from the first printer, the response email comprising the retained print job.

16. The method of claim 15 wherein the request email further includes a subject line comprising an application name indicating a process for parsing the request email at the destination address, the application name separated by a delimiting character from an indication of a type of data the parsing process is to expect.

17. A method for handling a retained print job comprising:
receiving at a first printer a request email comprising a job name for the retained print job that is stored on the first printer, the request email further comprising a destination address; and
transmitting, to the destination address, a response email from the first printer, the response email comprising the retained print job.

18. The method of claim 17 wherein the destination address is a second printer having an embedded web server.

19. A method for handling a retained print job comprising:
receiving at a first printer a request from a job owner to email the retained print job to a destination address;
parsing the request to determine a job name for the retained print job and an application in the first printer to execute the request;
packaging the retained print job indicated by the job name into a response email; and
transmitting the response email to the destination address.

20. The method of claim 19 and further including comparing a received personal identification indication to a stored personal identification indication in order to identify the job owner.

21. The method of 19 wherein the destination address is a second printer.

22. A method for handling a retained print job comprising:
receiving a reply email at a destination printer, the reply email comprising the retained print job;
parsing the reply email to determine an application in the destination printer to execute the reply email;
storing the retained print job in the destination printer; and
indicating receipt of the retained print job.

23. The method of claim 22 wherein indicating receipt includes generating, on the destination printer, an indication of available options for disposition of the retained print job.

24. The method of claim 23 wherein the available options include printing the retained print job.

25. A printing system comprising:
a first printer coupled to a first network and comprising:
an embedded web server that is compliant in email protocol; and
memory for storing a retained print job;
a computer coupled to the first network for transmitting an email requesting the retained print job be sent to a destination address; and
a second printer that is assigned the destination address and coupled to the first network such that the second printer receives a reply email comprising the retained print job.

26. The printing system of claim 25 and further including a firewall server coupling the first printer to the network.

27. The printing system of claim 25 wherein the computer and second printer are part of a second network that is coupled to the first network through a firewall server.

28. The printing system of claim 25 wherein the first network is the Internet.

29. The printing system of claim 25 wherein the second printer comprises:
an embedded web server that is compliant in email protocol; and
memory for storing the retained job from the reply email.

30. A printer comprising:
an embedded web server that is compliant in an email protocol;
memory for storing a retained print job having a print job name;
a controller that is capable of receiving an email comprising the print job name and replying to a destination address in the email with the retained print job.

31. The printer of claim 30 wherein the email protocol includes SMTP and POP3.

32. A method for generating an email for requesting a retained print job, the method comprising:
creating an email address field indicating an address for a printer that has the retained print job;
creating a subject field comprising an application name and a data type that are separated by a delimiting character, the application name indicating a process that is executed by a destination printer's embedded web server, the application name expecting a type of data specified by the data type;
creating a body field comprising a name indicating the retained print job and a destination address to which the retained print job is to be transmitted.

33. The method of claim 32 wherein the body field further comprises a personal identification indication that indicates an owner of the retained print job.

34. A printing device comprising:
means for transmitting a first email to a printer that retains a print job, the first email comprising a request for the retained print job that is stored on the printer; and
means for receiving a second email from the printer that retains the retained print job, the second email comprising the retained print job.

35. A printer comprising:
means for receiving a reply email at the printer, the reply email comprising the retained print job;
means for parsing the reply email to determine an application in the printer to execute the reply email;
means for storing the retained print job in the printer; and
means for indicating receipt of the retained print job.

36. A program storage device readable by a controller, tangibly embodying a program of instructions executable by the controller to perform a method for requesting a retained print job via email, said method comprising:
transmitting a first email to a first printer, the first email comprising a request for the retained print job that is stored on the first printer; and
receiving a second email from the first printer, the second email comprising the retained print job.

37. A program storage device readable by a controller, tangibly embodying a program of instructions executable by the controller to perform a method for requesting a retained print job via email, said method comprising:
transmitting a requesting email to a first printer, the requesting email comprising a request for a retained print job that is stored on the first printer;
receiving a response email from the first printer, the response email comprising the retained print job; and
printing the retained print job on the second printer.

38. A program storage device readable by a controller, tangibly embodying a program of instructions executable by the controller to perform a method for requesting a retained print job via email, said method comprising:
receiving at a first printer a request from a job owner to email the retained print job to a destination address;
parsing the request to determine a job name for the retained print job and an application in the first printer to execute the request;
packaging the retained print job indicated by the job name into a response email; and
transmitting the response email to the destination address.
